(19) United States
(12) Patent Application Publication
(10) Pub. No.: US 2022/0014146 A1
(43) Pub. Date: Jan. 13, 2022

(54) METHOD AND SYSTEM OF REPAIRING A SOLAR STATION

(71) Applicant: ABB Schweiz AG, Baden (CH)

(72) Inventors: Karen J. Smiley, Raleigh, NC (US); Alok Kucheria, Cary, NC (US); Melwin Jose, San Jose, CA (US); Xiao Qu, Cary, NC (US)

(21) Appl. No.: 16/923,339

(22) Filed: Jul. 8, 2020

(51) Int. Cl. H02S 50/10; G06F 16/2458; G06N 20/00; G06N 5/04

(52) U.S. Cl. CPC H02S 50/10; G06N 5/04; G06N 20/00; G06F 16/2477

(57) ABSTRACT

A method and system are provided for cost effectively and efficiently maintaining equipment in a solar station. In the method and system, data is acquired from different sources. The data sets are aligned with each other using time-stamps and location-stamps provided with each data set. The aligned data sets are then compared to identify conditions of the equipment in need of repair.

### BACKGROUND

The present inventions relate generally to solar power generation, and more particularly, to maintaining equipment in a solar station.

The generation of electrical power from solar panels is becoming more common and desirable due to decreased costs and environmental concerns. However, the impact of soft costs in the operations and maintenance (O&M) phase of solar power generation is often overlooked for prosumers (residential, commercial and industrial solar). The increasing use of photovoltaic solar power generation raises the importance of (1) gaining efficiencies during O&M over the 25+ year expected life of a solar installation, and (2) keeping solar power production at its maximum by catching and addressing issues as early as possible. Manual inspection by technicians of wiring and devices in solar installations, e.g., panels, inverters, etc., is costly and infrequently performed for prosumer solar facilities due to the time and effort required. Drones could also be used for inspection but are expensive, somewhat intrusive and may involve some safety concerns.

### SUMMARY

A method and system are described for repairing equipment in a solar station. The method and system receives data from at least two different data sources where both data sets are time-stamped and location-stamped. The data sets are then aligned with each other using the time-stamps and location-stamps and are compared to identify the condition of equipment in the solar station. Based on the conditions identified by the method and system, individual equipment in the solar station can be repaired cost-effectively and efficiently in order to maintain high power production from the station. The invention may also include any other aspect described below in the written description or in the attached drawings and any combinations thereof.

### BRIEF DESCRIPTION OF SEVERAL VIEWS OF THE DRAWINGS

The invention may be more fully understood by reading the following description in conjunction with the drawings, in which:

FIG. 1 is a schematic of a system and method of repairing a solar station.

### DETAILED DESCRIPTION

Diagnosing the condition of equipment may focus on a single data type or technology, e.g. telemetry, events, or images. When multiple types of data are available, the data sets are typically analyzed in isolation, e.g., image recognition machine learning (ML) algorithms operate on the images, other algorithms operate on telemetry, and a third set of analytics operate on events. Preferably, two or more data types, i.e. multi-modal data, may be leveraged by aligning the data based on location and time-stamp, automatically tagging images, and then applying ML. Using the telemetry raw values or derived values with images enables insights to be developed that are either not possible from looking at just one mode or not sufficiently accurate. One major benefit of such automatic tagging is overcoming the common problem of the high burden of human tagging of images, which often results in not having enough tagged imagery to feed into analytics. The increased accuracy may speed diagnosis and reduce maintenance costs.

It would be desirable to provide improved methods for detecting the condition of and problems with equipment in solar plants. In monitoring the condition of equipment, it is possible to analyze telemetry and events. It is understood that telemetry data refers to data received from onsite sensors that continuously monitor equipment in the solar station. Such sensors may include various types of power measurements, such as current sensors, voltage sensors or energy sensors, and may also include various hardware sensors, such as position sensors. Telemetry data may be event data or data logs as commonly recorded by existing equipment monitoring systems. In one method of equipment monitoring, drone manufacturers and service providers fly drones over the equipment, and humans (or alternatively, computer algorithms may be used) analyze the images. However, in this variation of the method, the image analysis is standalone. That is, other service providers rely on telemetry-based analytics alone. Thus, the associated telemetry is not considered when analyzing images. Telemetry data may be useful to pinpoint whether something that is detected on an image is associated with reduced power production or not. However, image analysis generally requires tagging of the images to designate whether the image represents a faulty condition or one that requires further investigation. Tagging is usually done by human experts, which is very costly and time-consuming.

In an improved method, location information (e.g., from GPS or other metadata) and time-stamps are used to associate (align and automatically tag) images or image regions with non-image data such as telemetry, events, service tickets, failure records, and other metadata. Although multiple non-numeric modes, e.g. categorical tags, may be used, hybrid image analytics may be extended to incorporate images with numerical time series tags.

In an improved method and system, multi-modal data (images and other types) are combined, automatic tagging is performed, and machine learning is applied to produce diagnoses of equipment condition. In a first step, location and time-stamp metadata on data from each mode may be processed to align times, coordinates, etc. (e.g., addresses may be mapped to GPS locations). Time-stamp granularities (resolutions) may also be processed to facilitate alignment. In a second step, a mapping table may be generated to link the multi-modal data sources based on the locations and time-stamps. In a third step, a set of analytic models may be trained and used for cross-validation. A single-mode analyses may be used initially and the modes may be combine later. For instance, if data modes/sources A, B and C are available, models using A alone, B alone and C alone may be developed. Then models may be generated for some or all of the permutations (in this example: A+B, B+C, A+C and A+B+C) based in part on the results of the single-mode models. In a fourth step, improvements in model accuracy which are gained with the multi-modal learning models may be analyzed and the best-performing solution may be determined or generated.

The method is most suitable for diagnosing equipment condition, probable causes and potential fixes. Other applications are also possible. Other variations could include a different order of generating the models. For instance, the model with all of the modes could be generated first, and the single-mode and permutations could be used for validation and refinement. It is also possible to use deep neural networks for combining and analyzing multi-modal data. For example, imagery and audio may be combined with a deep neural network to do automatic captions.

The methods herein may be used to improve current commercial solar facility inspection offerings by combining images and GPS locations from drones and satellites with monitoring data from inverters and weather devices to increase diagnostic accuracy, maximize flexibility, and minimize cost. Data-driven techniques may be used to automate and accelerate solar plant inspections and enable selective, cost-efficient deployment of device technologies such as smart drones. As a result, O&M soft costs may be significantly reduced, which may enable service providers to effectively scale their offerings to the prosumer market and enable catching solar power production problems sooner.

Although it is possible to use imaging or telemetry alone to monitor equipment condition, it may be preferable to use offsite data-driven analytics to strategically determine when to send drones equipped with sensors (e.g., video, infrared, thermal cameras) and GPS to collect diagnostic images and location data about in-plant devices. By utilizing monitoring data and analytics to automatically tag satellite and drone images and by applying image processing and machine learning techniques, captured data may be matched with data from faulty and healthy devices to identify failures or to check if devices are under-performing. Inspection results may be used to notify solar service providers or prosumer owners/operators about devices that need attention to maximize solar production. Such a system using multiple data sources may drastically reduce the time and effort spent to detect and localize problems affecting solar production. This may make the inspection of solar plant equipment installed in remote and hard to reach locations easier, safer and more timely.

The methods herein may support service providers to prosumers (residential, commercial and industrial solar owners). Manual inspection by trained technicians of wiring and devices in prosumer solar installations, e.g., panels and inverters, is not commonly performed frequently due to high soft costs, i.e., the time and effort required. However, the methods herein apply and combine inspection technologies and data-driven techniques to automate and accelerate inspections of solar equipment to significantly reduce O&M soft costs, thereby enabling earlier discovery and resolution of solar power production problems in a more cost-effective way.

Inspections of prosumer solar installations may be automated by combining multiple technologies and data sources. Machine learning (ML) models may also augment inspection solutions. Data sources may include: telemetry and events data, e.g., from inverters, meters, loggers and on-site environmental stations; weather data, e.g., from the nearest weather station to each installation, data from on-site weather stations if available, or a weather provider; satellite images, e.g., from publicly available sources or a service provider; and/or drone images, e.g., collected using UAVs with advanced sensors like infrared or thermal imaging to scan installations and extract image data or using on-drone analytics.

While each of these data sets alone may provide useful insights into solar equipment faults, combining the data sets may deliver added value. Telemetry data may be used to identify potential faults (e.g., damage due to grid inrush) or emerging patterns that might lead to faults. Satellite images may be analyzed to detect gradual losses due to natural causes like shading and vegetation or sudden drops in power production due to storm damage. Drones may provide up-to-date insights on the installation condition. Weather data may strengthen these analyses with irradiance measures, cloud cover, etc. Mapping satellite and drone images to relevant telemetry time-stamps and weather conditions may provide a better picture of installation health and degradation over time. Augmenting data-driven models by automatically tagging image data with fresh telemetry data by time-stamp and location-stamp may bring insights into the models and help service providers decide when and how to carry out inspections and repairs. Comprehensive machine learning models may be built using both visual and numerical performance data from the hybrid data sources, providing insights over multiple time frames.

Some monitoring approaches may use telemetry and weather data to analyze the status of solar equipment. Drone-based inspections may also be used. For example, real-time equipment imaging using drones with thermal cameras may be used. In some cases, solar panel identification may be performed by humans. Alternatively, some drones may monitor photovoltaic performance using analytics. In such case, the analytics may primarily focus on fault detection of solar panels. Machine learning models may also be built using drone images to identify defects in solar equipment. Satellite data may also be used to locate and count solar panels across contiguous regions. However, it is preferable to combine images and telemetry to provide improved equipment condition monitoring.

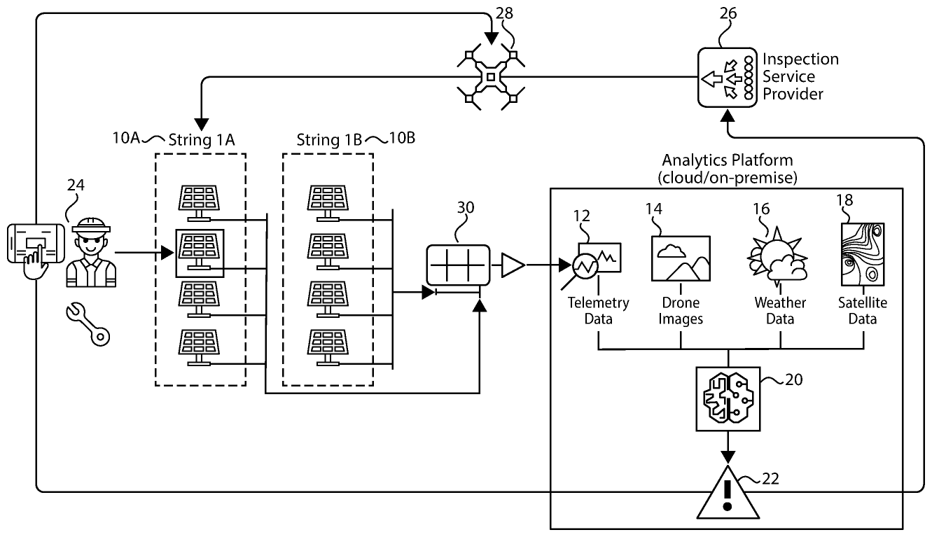

The present inventions may utilize a hybrid model based on combining imagery with telemetry, which current solutions for monitoring and inspection do not provide. In the present solution, multiple sources of data as indicated above and data driven approaches are used to overcome drawbacks of the existing solutions, and thus, enable faster inspection of various solar devices with the least amount of human intervention. Machine learning algorithms may be used to compare the data sets. For example, as shown in FIG. 1, ML algorithms 20 may be used to identify potential defects based on telemetry and event data 12, satellite images 18, drone images 14 and weather data 16. The system may also notify 22 prosumer service providers 26 of issues identified by the ML algorithm 20. The service provider system 26 may be cloud based or on-premise. A drone 28 operator may also monitor drone operation and on-drone analytics results and capture additional images or data. A field technician 24 who performs repairs of the solar station 10A, B may also capture images and other data associated with a repair using a drone 28. Monitoring of drone operation may be done on a computer tablet or mobile device. A real-time, small-footprint ML algorithm may also be used on the drone 28 to detect devices of interest and potential faults in those devices during drone flight and communicate such information to the field technician 24.

As shown in FIG. 1, at least two sets of data 12, 14, 16, 18 are received for analysis. The sets of data may include telemetry data 12 (i.e., performance data for the solar station, for example, some form of power output measurement), drone images 14, weather data 16 and satellite data 18. Although at least two data sets are preferred, it may be desirable to include three data sets or even four data sets or more. Each of the data sets are also preferably time-stamped and location-stamped. Location-stamped data may also be referred to as geospatial data or geolocation data. This allows the different data sets to be aligned with each other using the time-stamps and the location-stamps. The aligned sets of data are then compared with each other to identify the condition of various equipment in the solar station. The identified condition may then be repaired by a service technician 24.

Examples of how the method may identify equipment conditions using different sets of data are numerous. In one such example, the telemetry data 12 may show a drop in performance of a solar panel 10A. However, the telemetry data 12 may be insufficient by itself to determine whether an actual problem exists, and if so, what type of problem exists and what type of service technician 24 is needed to fix the problem. By comparing the telemetry data 12 with aligned weather data 16, it may be determined that a cloud passed during the drop in performance and that no problem exists. On the other hand, the weather data 16 may indicate that there was no weather related reason for the drop and a problem with the solar panel 10A likely exists. A drone 28 may then be sent to collect drone images 14 or satellite data 18 may be referred to in order to further determine the reason for the performance drop. This may reveal that the solar panel 10A is facing in the wrong direction which requires one type of technician 24 to fix the problem, or it may be revealed that a tree or branch has fallen on the solar panel 10A which requires a different type of technician 24 to fix the problem.

Typically, the frequency of data collection used for the different data sets 12, 14, 16, 18 will be different from each other. For example, the frequency of data collection for the telemetry data 12 may be less than a minute and is usually less than a second. On the other hand, drone images 14, weather data 16 and satellite data 18 may be more than a minute and is usually hourly or daily. It may also be useful to analyze at least two data sets without drone images 14 first before sending a drone 28 to collect images 14 in order to minimize costs and inconveniences. Thus, where two data sets have identified an equipment condition, a drone 28 may then be sent up to collect images 14 which are also time-stamped and location-stamped. However, it may also be desirable for drone images 14 to be collected and compared with the telemetry data 12 alone to provide quicker responses to possible equipment problems. The drone images 14 may then be aligned and compared with the first two data sets to further identify the equipment condition. In each case, comparing the aligned data sets is preferably performed using machine learning 20 to improve accuracy (or other relevant metrics) and decrease costs.

An automated analysis using telemetry, weather and image data may run in the background. The improved solution may also generate inspection reports and recommendations that selectively incorporate drone-based imaging in various operating scenarios, such as on a trigger where the service provider contacts the prosumer based on an alert raised by the ML system, on a schedule with periodic reporting, e.g., weekly or daily, or on demand where a customer contacts a service provider to request an inspection and report or uses a service provider web portal. In each scenario, the system may generate a report from the available data. If a drone survey is recommended and the customer agrees, the service provider may deliver updated results from a drone survey.

Use of the solution with multiple sources of data may be illustrated with an example in which a solar panel has started to underperform, either due to a fault in the hardware or an environmental condition. With existing systems, the fault may remain undiagnosed until the next periodic inspection. This delay prolongs the reduction in energy production. The improved system may include the following steps, where the first two steps reflect the trigger scenario. In the first step, a problem is detected. In this step, ML models 20 are trained on historical telemetry data 12, images (satellite 18 and drone 14), and weather data 16 to monitor for non-optimal operations. When a solar panel starts to underperform, this may be reflected in DC voltage readings (i.e., a power output of the solar station 10A, B, or other performance data of the solar station 10A, B) which are collected at the inverter 30 for the string 10A, B connected to the solar panel (telemetry). The ML system 20 identifies the problem and localizes a small area for diagnosis by utilizing inverter location information. In the second step, a service provider is dispatched to the solar station 10A, 10B. In this step, the system notifies 22 a service provider 24, 26 to have a drone 28 scan the sub-section 10A, 10B of the facility with all panels connected to the string which had sub-optimal DC readings. In the third step, a diagnosis of the problem is determined. In this step, the drone 28 fitted with a video and thermal camera captures images of panels and matches them with patterns of known faults. The drone operator 24 may use a mobile app connected to the system to identify the faulty panel along with possible tools or parts to resolve the issue. In the fourth step, the problem is repaired. In this step, the technician 24 visits the panel with recommended tools and parts to fix the problem, minimizing visits to the site 10A, B. The technician 24 may use a mobile device with an app to capture and tag image data before and after the repair, which may be used to improve the performance of the ML algorithms 20. It is understood that the method and system herein need not always result in a direct repair of equipment since the method and system are useful for general maintenance monitoring and can be used to predict future repairs. Moreover, general maintenance that is done in response to the data collection herein is considered to be a type of repair of the solar station.

The system herein may be extended to support the operation and maintenance of any solar station equipment, like photovoltaic panels, inverters, meters or environmental stations. The system may be useful in reducing the human time and effort put into solar facility operation and maintenance and may provide a platform that delivers timely updates on various solar equipment and enable prosumer service providers to take actions to maximize energy production. Gradual or sudden degradation, or decreased predictability and reliability, of solar power production adversely impacts the return on investment for prosumers. This may also affect grid operators who must adapt to the resulting fluctuations or increases in net demand. To support high solar power penetration, service providers must be able to leverage their personnel and scale up their offerings to prosumers in an efficient and cost-effective way. Thus, the preferred method and system herein improves at least four aspects of residential and commercial O&M costs: system inspection and monitoring, component parts replacement, module cleaning and vegetation management, and inverter replacement. Thus, the system may be useful in sustaining maximal solar power production and reduce O&M soft costs over the 25+ year operating life of prosumer solar facilities. The system may efficiently and affordably: drive more effective always-on remote monitoring services and diagnostic services; determine when sending out a drone to perform deeper diagnostic analyses is or is not warranted; localize sub-sites of suspected degradation or damage, enabling a service provider to efficiently plan and target deployments of drones and/or service and repair personnel; and minimize costs, safety risks and prosumer inconveniences related to drone usage. By reducing O&M soft costs, the method and system may make it more cost-effective in high-penetration scenarios for solar service providers to offer services to prosumers for efficiently detecting, diagnosing and addressing factors impairing their solar power production. Catching and mitigating these problems sooner and less expensively may benefit prosumers, as well as the operators of power grids. Additionally, the method and systems herein may be used by and benefit utility plants and grid operators.

While preferred embodiments of the inventions have been described, it should be understood that the inventions are not so limited, and modifications may be made without departing from the inventions herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

1. A method of repairing a solar station, comprising:
receiving first data from the solar station, the first data being time-stamped and location-stamped, and the first data being telemetry data;
receiving second data from the solar station, the second data being time-stamped and location-stamped, and the second data being drone images, weather data or satellite data;
aligning the first data and the second data using the time-stamps and the location-stamps;
comparing the aligned first and second data to identify an equipment condition; and
repairing the identified equipment condition.

2. The method according to claim 1, wherein the telemetry data comprises performance data of the solar station.

3. The method according to claim 2, wherein the performance data comprises a power output of the solar station.

4. The method according to claim 1, wherein the frequency of the first data is less than a minute, and the frequency of the second data is more than a minute.

5. The method according to claim 1, wherein comparing the aligned first and second data comprises machine learning to identify the equipment condition.

6. The method according to claim 1, wherein the second data is the drone images.

7. The method according to claim 6, further comprising receiving third data from the solar station, the third data being time-stamped and location-stamped, and the third data being the weather data, wherein the first, second and third data are aligned using the time-stamps and the location-stamps and compared to identify the equipment condition.

8. The method according to claim 7, wherein comparing the aligned first, second and third data comprises machine learning to identify the equipment condition.

9. The method according to claim 8, wherein the telemetry data comprises performance data of the solar station.

10. The method according to claim 9, wherein the performance data comprises a power output of the solar station.

11. The method according to claim 7, further comprising receiving fourth data from the solar station, the fourth data being time-stamped and location-stamped, and the fourth data being the satellite data, wherein the first, second, third and fourth data are aligned using the time-stamps and the location-stamps and compared to identify the equipment condition.

12. The method according to claim 11, wherein comparing the aligned first, second, third and fourth data comprises machine learning to identify the equipment condition.

13. The method according to claim 6, further comprising receiving third data from the solar station, the third data being time-stamped and location-stamped, and the third data being the satellite data, wherein the first, second and third data are aligned using the time-stamps and the location-stamps and compared to identify the equipment condition.

14. The method according to claim 13, wherein comparing the aligned first, second and third data comprises machine learning to identify the equipment condition.

15. The method according to claim 1, wherein the second data is the weather data.

16. The method according to claim 15, further comprising receiving third data from the solar station, the third data being time-stamped and location-stamped, and the third data being the satellite data, wherein the first, second and third data are aligned using the time-stamps and the location-stamps and compared to identify the equipment condition.

17. The method according to claim 16, wherein comparing the aligned first, second and third data comprises machine learning to identify the equipment condition.

18. The method according to claim 1, wherein the second data is the satellite data.

19. The method according to claim 1, wherein the second data is the weather data or the satellite data, and further comprising sending a drone to collect drone images of the equipment based on the identified equipment condition, the drone images being used to further identify the equipment condition.

20. The method according to claim 19, wherein the drone images are time-stamped and location-stamped and are aligned with the first and second data and compared with the aligned first and second data to further identify the equipment condition.
